(19) United States
(12) Patent Application Publication
(10) Pub. No.: US 2025/0375725 A1
(43) Pub. Date: Dec. 11, 2025

(54) DEVICE FOR CLEANING AND/OR SUCTIONING PILE FIBERS FOR PILE CLOTH FILTRATION

(71) Applicant: Mecana AG, Reichenburg (CH)

(72) Inventors: Thomas FUNDNEIDER, Reichenburg (CH); Ulrich GRABBE, Buttikon (CH)

(73) Assignee: Mecana AG, Reichenburg (CH)

(21) Appl. No.: 18/876,719

(22) PCT Filed: Jul. 20, 2023
(86) PCT No.: PCT/EP2023/070178

§ 371 Date: Dec. 19, 2024

(30) Foreign Application Priority Data
Jul. 25, 2022 (DE) 10 2022 118 497.8

(51) Int. Cl. B01D 41/00; D01G 1/00

(52) U.S. Cl. CPC B01D 41/00; D01G 1/00

(57) ABSTRACT

A device for cleaning and/or suctioning pile fibers for pile fabric filtration can be brought into a fluid connection with a suction source and includes at least one suction slot. The device for cleaning and/or suctioning has structure for mechanically cleaning, restoring and profiling the pile fibers. The structure increases the cleaning effect and simultaneously realigns the pile fibers and thus restores the pile fibers layer.

The present invention relates to a device for cleaning and/or suctioning pile fibres for pile fabric filtration, wherein the device can be brought into a fluid connection with a suction source and comprises at least one suction slot.

In this context, the fluid connection to a suction source can be both a liquid connection and a gas connection, in particular an air connection, or a combination of a liquid and a gas connection, wherein the first option is preferred.

It relates in general to devices for water and wastewater treatment and/or gas/steam treatment. In particular, the present invention relates to stationary filtration using cloth media, which have a cloth-media carrier structure, which forms the discharge space for conducting away the filtered inflow (cloth filtration).

For water and wastewater treatment, there are a large number of filter systems using fabrics. However, these systems have rotating frames, which carry the filter medium, and/or require separate discharge ducts for conducting away the wastewater. Known disc filtration systems, for example that in U.S. Pat. No. 4,639,315 A, generally have a tank comprising an inlet and an outlet as well as a rotatable filter frame assembly, which is arranged between the inlet and the outlet. The fabric filter medium is tensioned by disc-shaped frame portions, which are connected to a rotatable support structure, e.g. a pipe. During filtration, the inflow flows into the tank and flows through the fabric filter medium, through the hollow disc frame portion and into the central discharge pipe in order to be drained out through the tank outlet. The fabric filter medium, as found in U.S. Pat. Nos. 5,374,360 A, 5,876,612 A and 6,090,298 A, is cleaned at regular intervals by various methods, e.g. by back-flushing and/or high-pressure spraying, while the discs are rotating.

Another filter system, as is known from U.S. Pat. No. 4,090,965 A, is generally referred to as drum filtration. In drum filtration systems, the fabric filter medium is tensioned by support frames, which form a large drum shape by contrast with discs. The drums are fastened to a central pipe structure and together form a rotatable filter frame assembly. During filtration, the inflow flows into the tank and passes through the fabric filter medium, wherein the suspended solids are deposited on the fabric. The filtered inflow flows through the central pipe of the filter frame and is conducted away through the tank outlet. In the same way as in disc filtration, the fabric filter medium is regularly cleaned during the rotation by back-flushing and the like.

In pile fabric filtration, the multidimensional filter medium consists of a non-filter-active carrier fabric and a pile made of pile threads, the so-called pile fibre layer, which provides a large surface area. A suctioning device is used cyclically in order to clean retained solids from the pile fabric and to maintain the filter capacity. As the deposits of solids in the filter fabric increase, the hydraulic resistance of the filter system namely increases.

The problem addressed by the present invention is to provide an improved cleaning device for pile fabric filtration.

In the context of the invention, this problem is solved in a device according to the preamble in that means structured either on the device for cleaning and/or suctioning or as a separate element therefrom for mechanically cleaning, restoring and/or profiling the pile fibres are provided, wherein the pile fibres can be aligned by the structured means in such a way as to correspond to the original state of the pile fibre layer.

While known devices for cleaning and/or suctioning are configured to be substantially smooth, the device according to the invention for cleaning and/or suctioning comprises structured means, i.e. projecting away from the surface of the suction lip, which increase the cleaning effect and simultaneously realign and clean the pile fibres and thus restore the pile fibre layer. The structured means form projections and/or recesses on the device for cleaning and/or suctioning and thus increase the cleaning effect and the restoration of the pile fibre layer, i.e. the alignment of the pile fibres, as corresponds to the original state of the pile fibre layer. This alignment/structuring/shaping of the pile fibres improves the filtration process. Alternatively, the structured means for mechanically cleaning, restoring and profiling the pile fibres can also be configured as an element or elements that are separate from the device for cleaning and/or suctioning. In this case, the structured means for mechanically cleaning, restoring and profiling the pile fibres can be moved independently of the device for cleaning and/or suctioning.

According to a preferred configuration of the invention, it is provided that the structured means for mechanically cleaning, restoring and/or profiling the pile fibres are arranged in the region of a suction lip of the device for cleaning and/or suctioning.

The suction lips are generally located in the vicinity of the suction slot. There can be one suction lip, but generally two or sometimes more than two suction lips are arranged around the suction slot.

The suction lip thus comprises structured means for mechanically cleaning, restoring and profiling the pile fibres, which are capable of, before and/or after and/or during the fluidisation of the pile fibre layer,
(a) mechanically cleaning the pile fibres, i.e. removing residues on the pile fibres and/or the pile fibre surface which are not removed, or only removed to an insufficient extent, by the conventional suctioning of the pile fibre layer,
(b) parallelising or structuring the pile fibres in order to restore the pile fibre layer in terms of its optimal filter effect,
(c) either decompressing or compressing the pile fibre layer,
and thus maintaining the filter capacity of the pile fibre layer by preventing the pile fibres from becoming tangled. The suction lip can be provided with the structured means for mechanically cleaning, restoring and profiling the pile fibre layer either in its entirety or in portions. The structured means for mechanically cleaning, restoring and/or profiling the pile fibres in the region can also be arranged within the suction slot in their entirety or in portions.

The structured means for mechanically cleaning, restoring and/or profiling the pile fibres can be used for targeted cleaning, both without simultaneous suction and also in combination with the suction of pile fibres, in order to reduce/minimise the filtrate-side spike owing to pile-thread/pile-fabric cleaning and/or the removal of a distinct filter cake within and/or above the pile fibre layer.

The upstream and/or downstream and/or integrated insertion of the structured means for mechanically cleaning, restoring and/or profiling the pile fibres can assist in removing dirt and/or can provide a defined distance between the pile fibre layer and the suction. The distance assists in removing the top layer formed on the pile fibre layer and thus increases the solids content in the waste flushing water.

According to the invention, it is provided that the structured means for mechanically cleaning, restoring and profiling the pile fibres are linked to the suction for fluidising and cleaning such that the structured means for mechanically cleaning, restoring and profiling the pile fibres are an integral part of the device for cleaning and/or suctioning. Alternatively, the structured means for mechanically cleaning, restoring and profiling the pile fibres can also be configured as a separate element or separate elements that can be connected to the device for cleaning and/or suctioning. In this case, the structured means for mechanically cleaning, restoring and profiling the pile fibres are movable independently of the device for cleaning and/or suctioning. The structured means for mechanically cleaning, restoring and profiling the pile fibres can be used independently of the device for cleaning and/or suctioning. The structured means for mechanically cleaning, restoring and profiling the pile fibres are rotatable about their x, y and/or z axis. The structured means for mechanically cleaning, restoring and profiling the pile fibres can be spring-mounted. In this case, it is advantageous for the contact pressure on the pile fibre layer to be variably adjustable.

The subject matter of the invention makes it possible to maintain the filter performance over a longer period of time independently of the pile fabric used, to increase the hydraulic and/or material load and to reduce the energy demand without modifying the existing filter machine and/or the pile fibre layer.

This makes it possible to reduce the costs of new or existing filtration systems by decreasing the size or number of filtration units required.

In this case, the cross section of the structured means for mechanically cleaning, restoring and profiling the pile fibres does not increase towards the pile fibre layer. The cross section of the structured means for mechanically cleaning, restoring and profiling the pile fibres is not greater at the end closest to the pile fibre layer than at the end remote from the pile fibre layer. The cross section of the structured means for mechanically cleaning, restoring and profiling the pile fibres does not increase towards the pile fibre layer. Advantageously, the structured means for mechanically cleaning, restoring and profiling the pile fibres can remove a distinct filter cake within the pile fibre layer, too.

It is part of the invention that the structured means for mechanically cleaning, restoring and profiling the pile fibres have an equivalent diameter of 1 to 4000 μm, preferably of 100 to 1000 μm, particularly preferably of 100 to 400 μm.

Advantageously, such an equivalent diameter allows for treatment of the single fibres of the pile fibre layer, wherein the entire pile fibre layer and/or individual layers of the pile fibre layer can be treated in the functional state.

In this case, the pile fibres can have a diameter of 0.2 to 200 μm, preferably of 1 to 50 μm, particularly preferably of 3 to 30 μm.

The equivalent diameter of the structured means for mechanically cleaning, restoring and profiling the pile fibres is preferably dependent on the equivalent diameter of the pile fibres. For example, the ratio of the equivalent diameter of the pile fibres to the equivalent diameter of the structured means for mechanically cleaning, restoring and profiling the pile fibres is 1:1 to 1:100, preferably 1:5 to 1:50, particularly preferably 1:25 to 1:40.

According to a preferred configuration of the invention, the structured means for mechanically cleaning, restoring and profiling the pile fibres are configured as fibres, pile fabric, bristles, teeth, horn-like teeth, studs, or as a combination thereof.

It is part of the invention that the structured means for mechanically cleaning, restoring and profiling the pile fibres are configured to be flexible.

Alternatively, it is also possible that the structured means for mechanically cleaning, restoring and profiling the pile fibres are configured to be rigid and/or fixed.

It is of course also possible to provide mixed forms, in which part of the structured means for mechanically cleaning, restoring and profiling the pile fibres is configured to be flexible and another part of the structured means for mechanically cleaning, restoring and profiling the pile fibres is configured to be rigid and/or fixed. Rigid or fixed structured means for mechanically cleaning, restoring and profiling the pile fibres can also be provided which are movable, for example by interposing a joint or a flexible region.

According to the invention, it is provided that the structured means for mechanically cleaning, restoring and profiling the pile fibres are configured to substantially vertically and/or tangentially point away from the plane of the device for cleaning and/or suctioning and/or to be oblique relative thereto.

When aligned obliquely, it is also possible for the structured means for mechanically cleaning, restoring and profiling the pile fibres to be arranged to be inclined towards or to point away from the pile threads of the pile fibre layer.

It is also possible here to provide mixed forms, in which part of the structured means for mechanically cleaning, restoring and profiling the pile fibres is configured to be inclined towards the pile threads and another part of the structured means for mechanically cleaning, restoring and profiling the pile fibres is configured to point away from the pile threads.

According to the invention, it is provided that the structured means for mechanically cleaning, restoring and profiling the pile fibres are arranged to be homogeneously distributed.

Alternatively, it is also possible that the structured means for mechanically cleaning, restoring and profiling the pile fibres are non-homogeneously distributed.

For example, the structured means for mechanically cleaning, restoring and profiling the pile fibres can be arranged as patterns, in particular circles, zig-zags, lines, in particular parallel lines perpendicular to the suction slot, wavy lines or mixed forms thereof.

A development of the invention is that the structured means for mechanically cleaning, restoring and profiling the pile fibres consist of plastics materials, such as polyethylene terephthalate, polypropylene, polyamide and/or of metals, in particular steel, preferably stainless steel, and/or of natural materials, in particular plant and/or animal fibres, wood or of combinations thereof.

A preferred configuration of the invention is that the structured means for mechanically cleaning, restoring and profiling the pile fibres are arranged on a holder that can be detachably fastened to the device for cleaning and/or suctioning. In this context, it is possible both that only the structured means for mechanically cleaning, restoring and profiling the pile fibres are arranged on the detachably fastened holder and also that the suction lip or suction lips are arranged on this holder in addition to these means.

Since the structured means for mechanically cleaning, restoring and profiling the pile fibres wear over time due to the friction between the pile threads and said means, it is sensible that they are arranged on a holder which can be detachably fastened to the device for cleaning and/or suctioning in the region of the suction lip or suction lips. Since the suction lip is also subjected to wear, it can be advantageous, in addition to the structured means for mechanically cleaning, restoring and profiling the pile fibres, to also arrange the suction lip on the interchangeable holder and to thus replace these two wear parts at the same time.

Particularly preferably, the holder can be detachably fastened to the device for cleaning and/or suctioning by a snap-in connection.

Alternatively, it is also possible that the structured means for mechanically cleaning, restoring and profiling the pile fibres cannot be detachably and/or movably fastened.

Exemplary embodiments of the invention are explained in greater detail in the following with reference to drawings, in which:

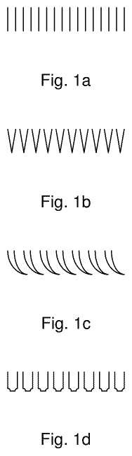

FIGS. 1a to 1d show different configurations of the structured means for mechanically cleaning, restoring and profiling the pile fibres,

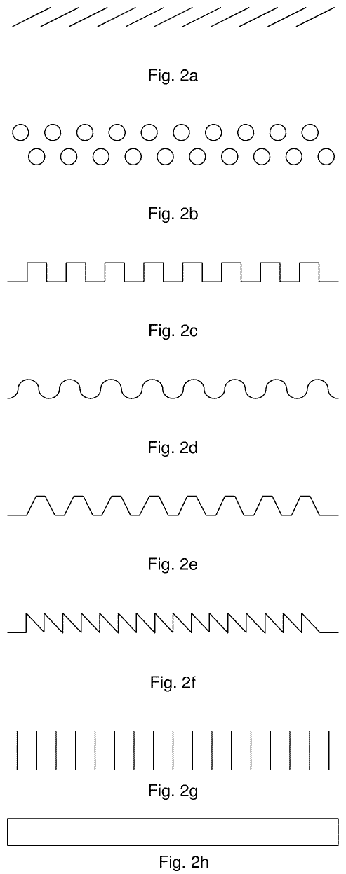

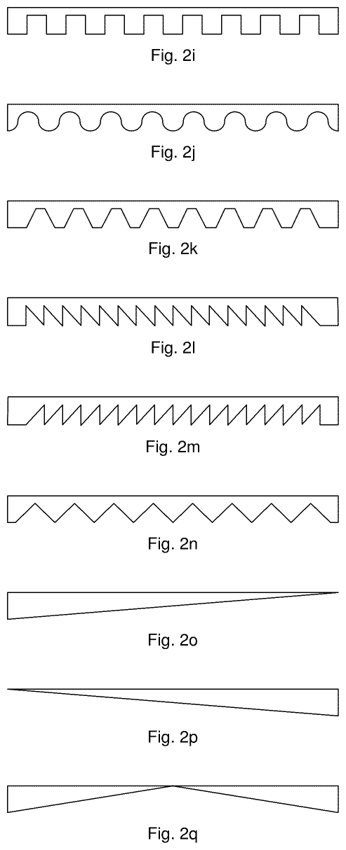

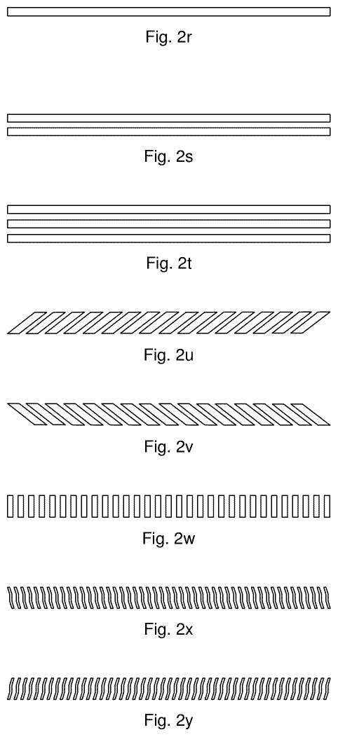

FIGS. 2a to 2y show different arrangements and profiles of the structured means for mechanically cleaning, restoring and profiling the pile fibres,

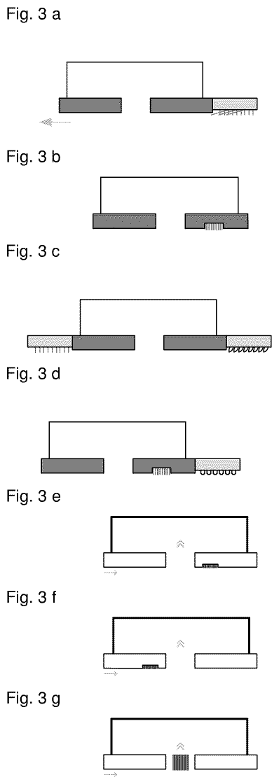

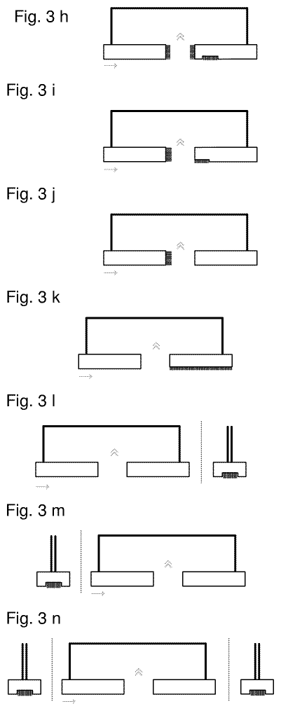

FIGS. 3a to 3n show different arrangements of the structured means for mechanically cleaning on the suctioning device or in combination with the suctioning device.

FIGS. 1a to 1d show different configurations of the structured means for mechanically cleaning, restoring and profiling the pile fibres. They can be configured as bristles (FIG. 1a), teeth (FIG. 1b), horn-like teeth (FIG. 1c) or studs (FIG. 1d). The structured means for mechanically cleaning, restoring and profiling the pile fibres can be configured to be rigid or fixed, wherein mixed forms are also possible.

The structured means for mechanically cleaning, restoring and profiling the pile fibres consist of plastics materials, such as polyethylene terephthalate, polypropylene, polyamide and/or of metals such as steel, in particular stainless steel, and/or of natural materials, such as plant and/or animal fibres, wood or of combinations thereof.

FIGS. 2a to 2g show different arrangements and profiles of the structured means for mechanically cleaning, restoring and profiling the pile fibres. They can not only be distributed homogeneously over the entire suction lip, but can also be non-homogeneously distributed or can only be in portions of the suction lip or can be perpendicular to the suction lip. They can both be arranged to be inclined towards or to point away from the pile threads and can be provided in mixed forms.

In particular, the structured means for mechanically cleaning, restoring and profiling the pile fibres can also be arranged in patterns, for example so as to be circular (FIG. 2a), in the form of a square wave (FIG. 2b) or so as be undulating or in the form of a wavy line (FIG. 2c). The structured means for mechanically cleaning can also be arranged in a zig-zag shape, wherein the zig-zags can be trapezoidal (FIG. 2d) or triangular (FIG. 2e) in cross section. Any other patterns are also possible, for example the arrangement in parallel rows (FIG. 2s and FIG. 2t). All of these patterns can also be in mixed forms, i.e. different patterns can be provided in combination with one another.

FIGS. 2h to 2q are side views of the profile of the structured means for mechanically cleaning, restoring and profiling the pile fibres from the movement direction of the suctioning device. The structured means for mechanically cleaning, restoring and profiling the pile fibres are accordingly arranged in different lengths in each of the surface areas shown. For example, in FIG. 2q, the length of the pile fibres is shorter in the centre than at either side.

FIGS. 2r to 2y show the arrangement pattern of the structured means for mechanically cleaning, restoring and profiling the pile fibres in a view from below of the suctioning device or the structured means for mechanically cleaning, restoring and profiling the pile fibres. The structured means for mechanically cleaning, restoring and profiling the pile fibres are accordingly arranged in each of the surface areas shown.

FIGS. 3a to 3n show different arrangements of the structured means for mechanically cleaning on the suctioning device.

In FIG. 3a, the movement direction of the suctioning device is indicated by an arrow. This suctioning direction also applies to FIGS. 3b to 3d. The movement direction can also be reversed.

FIGS. 3e to 3k show further arrangements of the structured means for mechanically cleaning on the suctioning device.

FIGS. 3l to 3n show different arrangements of the structured means for mechanically cleaning so as to be spatially separated from the suctioning device. In this case, the structured means for mechanically cleaning can be moved independently of the suctioning device.

In FIGS. 3g to 3j, the structured means for mechanically cleaning are arranged within the suction slot.

FIGS. 3e to 3n show the movement direction of the suctioning device and/or the structured means for mechanically cleaning by means of an arrow. The movement direction can also be reversed. The flow direction of the fluid during the suctioning process during filter cleaning is indicated by a double-headed arrow.

FIG. 3c shows a suctioning device comprising upstream and downstream bristles. The upstream bristles loosen the dirt from the pile fibres, which is picked up by the suctioning device, and the downstream bristles restore the pile fibre layer.

1. A device for cleaning and/or suctioning pile fibers for pile fabric filtration, wherein the device for cleaning and/or suctioning can be brought into a fluid connection with a suction source and comprises at least one suction slot, wherein means structured either on the device for cleaning and/or suctioning or as a separate element therefrom for mechanically cleaning, restoring and profiling the pile fibers are provided, wherein the pile fibers can be aligned by the structured means in such a way as to correspond to the original state of the pile fibers layer, so as to parallelize or structure the pile fibers in order to restore the pile fiber layer in terms of its optimal filter effect, wherein the structured means for mechanically cleaning, restoring and profiling the pile fibers are configured as fibers, pile fabric, bristles, studs, or as a combination thereof and have an equivalent diameter of 1 to 4000 μm, and wherein the pile fibers have a diameter of 0.2 to 200 μm.

2. The device according to claim 1, wherein the structured means for mechanically cleaning, restoring and profiling the pile fibers have an equivalent diameter of 100 to 1000 μm, particularly preferably of 100 to 400 μm.

3. The device according to claim 1, wherein the means for mechanically cleaning, restoring and profiling the pile fibers are arranged in the region of a suction lip of the device for cleaning and/or suctioning.

4. The device according to claim 1, wherein the pile fibers have a diameter of 1 to 50 μm, particularly preferably of 3 to 30 μm.

5. The device according to claim 1, wherein the structured means for mechanically cleaning, restoring and profiling the pile fibers are configured to be flexible.

6. The device according to claim 1, wherein the structured means for mechanically cleaning, restoring and profiling the pile fibers are configured to be rigid and/or fixed.

7. The device according to claim 1, wherein the structured means for mechanically cleaning, restoring and profiling the pile fibers are configured to vertically and/or tangentially point away from the plane of the device for cleaning and/or suctioning or to be oblique relative thereto.

8. The device according to claim 1, wherein the structured means for mechanically cleaning, restoring and profiling the pile fibers are arranged to be inclined towards or to point away from the pile threads of the pile fiber layer.

9. The device according to claim 1, wherein the structured means for mechanically cleaning, restoring and profiling the pile fibers are arranged to be homogeneously distributed.

10. The device according to claim 1, wherein the structured means for mechanically cleaning, restoring and profiling the pile fibers are non-homogeneously distributed.

11. The device according to claim 1, wherein the structured means for mechanically cleaning, restoring and profiling the pile fibers comprise plastics materials, such as polyethylene terephthalate, polypropylene, polyamide and/or of metals, in particular steel, preferably stainless steel, and/or of natural materials, in particular plant and/or animal fibers, wood or of combinations thereof.

12. The device according to claim 1, wherein the structured means for mechanically cleaning, restoring and profiling the pile fibers are arranged on a holder that can be detachably fastened to the device for cleaning and suctioning.

13. The device according to claim 12, wherein the holder can be detachably fastened to the device for cleaning and suctioning by a snap-in connection.
